(19) United States
(12) Patent Application Publication
(10) Pub. No.: US 2014/0035876 A1
(43) Pub. Date: Feb. 6, 2014

(54) Command of a Computing Device

(71) Applicant: Randy Huang, Taipei (TW)

(72) Inventor: Randy Huang, Taipei (TW)

(21) Appl. No.: 13/563,544

(22) Filed: Jul. 31, 2012

(51) Int. Cl. G06F 3/041; G06F 3/042

(52) U.S. Cl. 345/175; 345/173

(57) ABSTRACT

A computing device to detect a first finger and a second finger at a surface of the computing device. The computing device determines an orientation of a second finger relative to a first finger position if the first finger is stationary at the surface. The computing device identifies a command of the computing device corresponding to the orientation of the second finger relative to the first finger position.

### BACKGROUND

When a user would like to enter one or more commands into a computing device, the user can access an input component, such as a keyboard and/or a mouse of the computing device. The user can use the keyboard and/or mouse to enter one or more inputs for the computing device to interpret. The computing device can proceed to identify and execute a command corresponding to the input received from the keyboard and/or the mouse.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing device with a sensor to detect a first finger and a second finger according to an example.

FIGS. 2A and 2B illustrates a sensor to detect an orientation of a second finger relative to a first finger position according to an example.

FIG. 3 illustrates a block diagram of an input application identifying a command of the computing device corresponding to an orientation of a second finger relative to a first finger position according to an example.

FIG. 4 is a flow chart illustrating a method for detecting an input according to an example.

FIG. 5 is a flow chart illustrating a method for detecting an input according to an example.

### DETAILED DESCRIPTION

A computing device includes a sensor, such as a touch surface, a touchpad, and/or a touch screen to detect for a first finger and a second finger of a user at a surface of the computing device. In one embodiment, the surface can be a touch sensitive panel of a touch surface, a touchpad, and/or a touch screen of the sensor. In another embodiment, the sensor can be an image capture component and the surface can include a panel of the computing device within view of the image capture component.

If the first finger is detected to be stationary at the surface, the computing device proceeds to determine an orientation of the second finger relative to a first finger position. For the purposes of this application, the orientation of the second finger corresponds to a location of the second finger relative to the position of the first finger. For example, the orientation of the second finger can be located to the bottom left of the first finger position. In another example, the orientation of the second finger can be located to the top right of the first finger position. In other embodiments, detecting the orientation of the second finger can include detecting for the second finger repositioning.

By initially detecting for the first finger being stationary, the computing device can reduce the amount of false input which may result from the first finger repositioning when moving a cursor or pointer of the computing device. Based on the orientation of the second finger relative to the first finger position, the computing device can identify a command of the computing device. For example, if the second finger is located to the bottom left of the first finger, the computing device can identify the command to be a left click or a select command of the computing device. In another example, if the second finger is located to the top right of the first finger, the computing device can identify the command to be a right click or a menu command of the computing device.

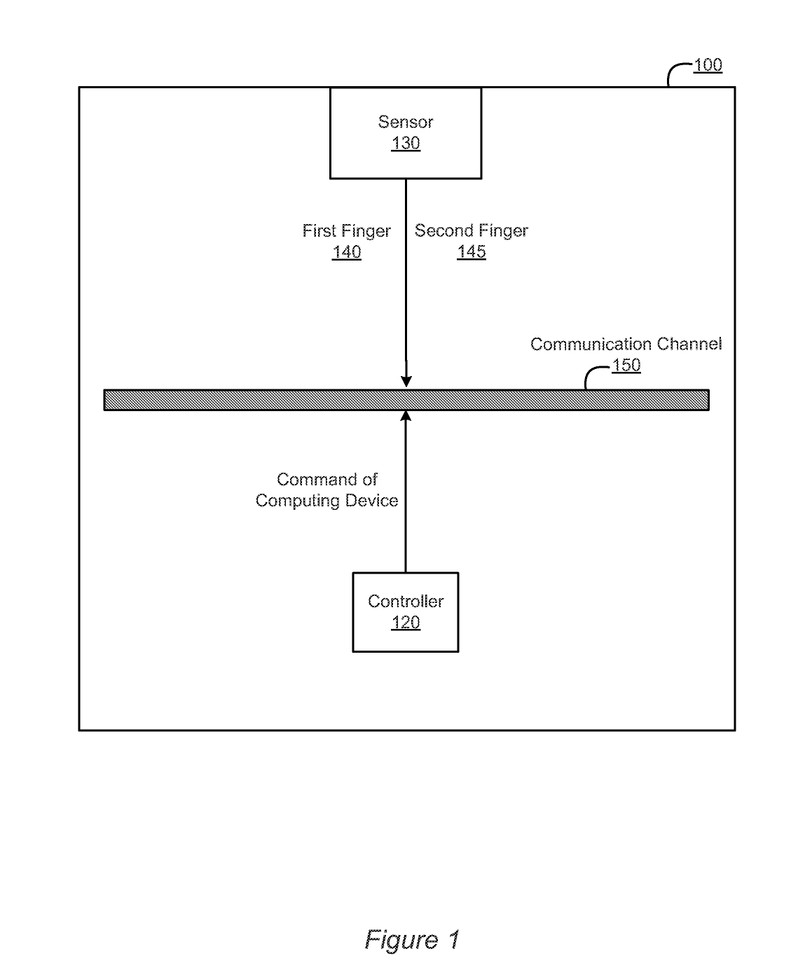

FIG. 1 illustrates a computing device 100 with a sensor 130 to detect a first finger 140 and a second finger 145 according to an example. In one embodiment, the computing device 100 can be a notebook, a netbook, a tablet, a desktop, a workstation, a server, and/or an all-in-one system. In another embodiment, the computing device 100 can be a cellular device, a smart phone, a PDA (Personal Digital Assistant), an E (Electronic)-Reader, and/or any additional computing device 100 with a sensor 130.

The computing device 100 includes a controller 120, a sensor 130, and a communication channel 150 for the computing device 100 and/or one or more components of the computing device 100 to communicate with one another. In one embodiment, the computing device 100 also includes an input application stored on a non-volatile computer readable medium included in or accessible to the computing device 100. For the purposes of this application, the input application is an application which can be utilized independently and/or in conjunction with the controller 120 to detect inputs for the computing device 100.

When detecting inputs, a sensor 130 is used to detect for a first finger 140 and a second finger 145 of a user at a surface of the computing device 100. The user can be any person which can enter inputs for the computing device 100 with the first finger 140 and the second finger 145. For the purposes of this application, the first finger 140 is a finger of the user which is initially detected by the sensor 130 at the surface of the computing device 100. The second finger 145 is a subsequent finger of the user detected at the surface of the computing device 100 after the first finger 140 is detected. For example, the first finger 140 can be a middle finger of the user initially detected at the surface and the second finger 145 can be an index finger subsequently detected at the surface. In another example, the first finger 140 can be a middle finger of the user initially detected at the surface and the second finger 145 can be a ring finger of the user subsequently detected at the surface.

For the purposes of this application, the sensor 130 is a hardware component of the device 100, such as a touch surface, a touch screen, a touchpad, and/or an image capture component which can detect for the first finger 140 and the second finger 145 at surface of the computing device 100. When detecting for the first finger 140 and the second finger at the surface, the sensor 130 can detect for the first finger 140 and the second finger 145 touching the surface. In another embodiment, the sensor 130 detects for the first finger 140 and the second finger 145 within proximity of the surface. For the purposes of this application, the surface includes a frame, a panel, an enclosure, and/or a casing of the computing device 100. In one embodiment, if the sensor 130 is coupled to the surface of the computing device 100, the surface can be a touch sensitive panel of the sensor 130.

If the sensor 130 detects the first finger 140 and the second finger 145 at the surface of the computing device 100, the controller 120 and/or the input application proceed to determine if the first finger 140 is stationary at the surface. The sensor 130 can detect for the first finger 140 repositioning. If the first finger 140 is not detected to reposition, the first finger 140 is determined to be stationary. If the first finger 140 is detected at the surface to be stationary, the controller 120 and/or the input application proceed to determine an orientation of the second finger 145 relative to a first finger position 140.

When determining the orientation of the second finger 145 relative to the first finger position 140, the sensor 130 detects for the first finger position 140 and the second finger position 145 at the surface of the computing device 100. In one embodiment, the sensor 130 detects a first coordinate corresponding to the first finger position 140 and a second coordinate corresponding to the second finger position 145. The sensor 130 can pass the first coordinate and the second coordinate to the controller 120 and/or the input application.

The controller 120 and/or the input application can then compare the first coordinate and the second coordinate to one another to identify the orientation of the second finger 145 relative to the first finger position 140. For example, if the second coordinate is located above and to the right of the first coordinate, the controller 120 and/or the input application determine that the second finger 145 is oriented to the upper right of the first finger 140. If the second coordinate is located lower and to the left of the first coordinate, the controller 120 and/or the input application determine that the second finger is oriented to the lower left of the first finger 140. In one embodiment, detecting the orientation of the second finger 145 relative to the first finger position 140 includes detecting for the second finger 145 repositioning. The second finger 145 can reposition along one or more axis while the first finger 140 is stationary.

Based on the orientation of the second finger 145 relative to the first finger position 140, the controller 120 and/or the input application proceed to identify a command of the computing device 100. For the purposes of this application, the command of the computing device 100 can be an instruction or command for the computing device 100 to perform an action. For example, the command can be an instruction to select content, an instruction to launch content, an instruction to launch a menu, an instruction to navigate through content, and/or an instruction to switch between content. The content can include media, a file, and/or an application accessible by the computing device 100.

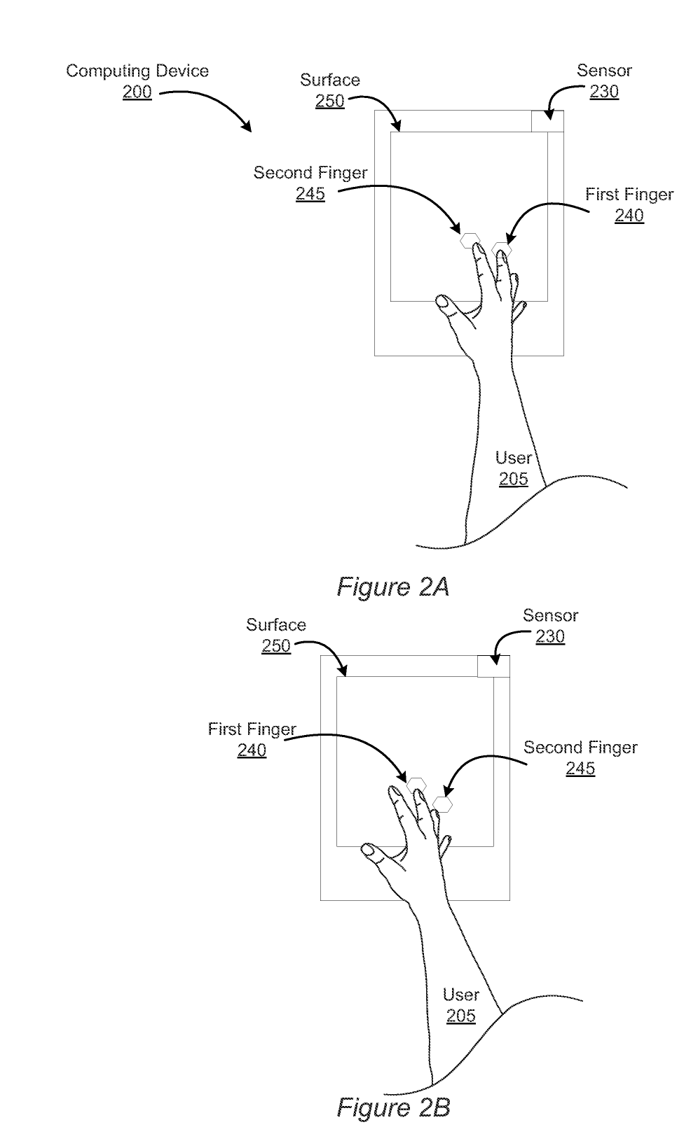

FIGS. 2A and 2B illustrates a sensor 230 to detect a first finger 240 and a second finger 245 at a surface 250 of a computing device 200 according to an example. For the purposes of this application, the sensor 230 is a hardware component of the computing device 200 which detects for a first finger 240 and a second finger 245 of a user 205 at surface 250 of the computing device 100. In one embodiment, the sensor 230 is a touchscreen, a touchpad, and/or a touch surface coupled to the surface 250. In another embodiment, the sensor 230 is an image capture component which can capture a view of the surface 250.

As shown in FIG. 2A, the surface 250 of the computing device 200 includes an enclosure, a panel, a casing, and/or a frame of the computing device 200. In one embodiment, if the surface is 250 is a touch panel of the sensor 230, the sensor 230 is coupled to or integrated with the surface 250 of the computing device 200. In another embodiment, if the sensor 230 is an image capture component, the sensor 230 can be separate from the surface 250 and the sensor 230 captures a view of the first finger 240 and the second finger 245 of a user 205 at the surface 250. The user can be any person which can enter inputs for the computing device 200 with the first finger 240 and the second finger 245. In one embodiment, the first finger 240 and the second finger 245 are both included on a single hand of the user 205. In another embodiment, the first finger 240 can be included on a first hand of the user 205 and the second finger 240 can be included on a second hand of the user 205.

For the purposes of this application, the first finger 240 corresponds to a finger of the user 205 initially detected by the sensor 230 at the surface 250. The second finger 245 corresponds to another finger of the user 205 subsequently detected by the sensor 230 at the surface 250 after the first finger 240 has been detected. When detecting for the first finger 240 and the second finger 245, the sensor 230 can detect for the first finger 240 and the second finger 245 within proximity of the surface 250. The first finger 240 and the second finger 245 are within proximity of the surface 250 if they are within a predefined distance from the surface 250. In another embodiment, when detecting for first finger 240 and the second finger 245, the sensor 230 can detect for the first finger 240 and the second finger 245 making contact with the surface 250.

In one example, as shown in FIG. 2A, the sensor 230 initially detects the first finger 240 (a middle finger of the user 205) at the surface 250 of the computing device 200. After the first finger 240 has been detected, the sensor 230 detects the second finger 245 (an index finger of the user 205) at the surface 250. As shown in the present example, the second finger 245 is positioned to the upper left of the first finger 240. In another example, as shown in FIG. 2B, the sensor 230 initially detects the first finger 240 (the middle finger of the user 205) at the surface 250 and subsequently detects the second finger 245 (a ring finger of the user 205) at the surface 250. As shown in the present example, the second finger 245 can be positioned to the lower right of the first finger 240.

In response to detecting the first finger 240 and the second finger 245 at the surface 250, the sensor 230 detects if the first finger 240 is stationary. When detecting if the first finger 240 is stationary, the sensor 230 detects if the first finger 240 is repositioning. The sensor 230 can detect a first coordinate of the first finger 240 and determine if the coordinate changes. If the first coordinate of the first finger 240 does not change, the sensor 230 determines that the first finger 240 is stationary and the controller and/or the input application proceed to determine an orientation of the second finger 245 relative to the first finger 240 position.

As noted above, the orientation of the second finger 245 corresponds to a location of the second finger 245 compared to the stationary first finger 240 position. When determining the orientation of the second finger 245 relative to the first finger 240 position, the controller and/or the input application can detect for a first coordinate at the surface 240 corresponding to the first finger 240 position and detect for a second coordinate at the surface 240 corresponding to the second finger 245 position. The first coordinate and the second coordinate correspond to locations of the surface 250 where the sensor 230 detects the first finger 240 and the second finger 245. Using the first coordinate and the second coordinate, the controller and/or the input application proceed to identify an orientation of the second finger 245 relative to the first finger 240 position.

In one embodiment, determining the orientation of the second finger 245 relative to the first finger 240 position includes determining if the second finger 245 is positioned to the left or the right of the first finger 240. The controller and/or the input application can also detect an angle of the second finger 245 relative to the first finger 240 position. Detecting the angle of the second finger 245 can include detecting the degrees of the second finger 245 orientation relative to the first finger 240 position.

For example, if the second coordinate is positioned to the upper right of the first coordinate, the controller and/or the input application determine that the second finger 245 is angled and oriented to the upper right of the first finger 240. The controller and/or the input application can also determine if the degrees of the second finger 245 is oriented 15 degrees, 30 degrees, 45 degrees, and/or any additional degree from the first finger 240 position. In another example, if the second coordinate is positioned to the lower left of the first coordinate, the controller and/or the input application determine that the second finger 245 is angled and oriented to the lower left of the first finger 240. The controller and/or the input application can also determine if the degrees of the second finger 245 is oriented 15 degrees, 30 degrees, 45 degrees, and/or any additional degree from the first finger 240 position.

In another embodiment, determining the orientation of the second finger 245 includes determining if the second finger 245 is repositioning as the first finger remains stationary. The controller and/or the input application can detect if the second coordinates are changing as the first coordinates remain stationary when detecting for the second finger 245 repositioning. Based on the changing coordinates, the controller and/or the input application can identify a direction of the second finger 245 repositioning. The controller and/or the input application then use the information of the orientation of the second finger 245 relative to the first finger position 240 to identify a command of the computing device 200.

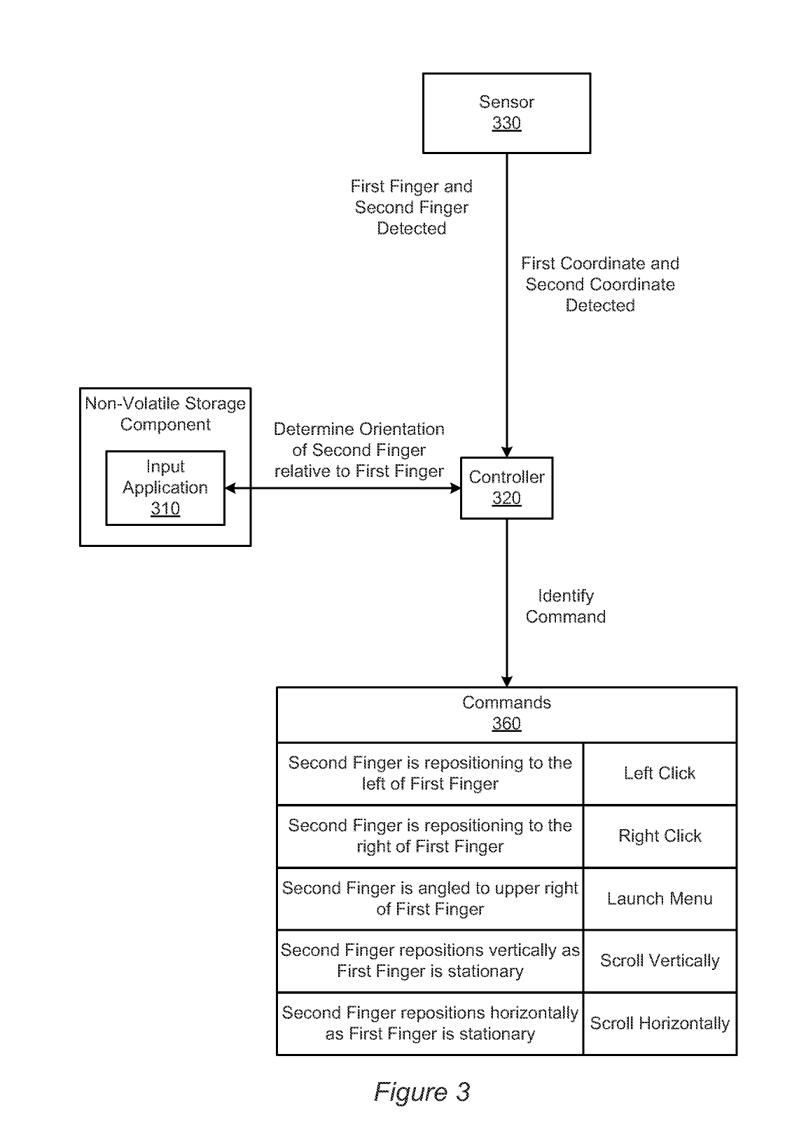

FIG. 3 illustrates a block diagram of an input application 310 identifying a command 360 of the computing device based on an orientation of a second finger relative to a first finger position according to an example. As noted above, the input application 310 is utilized independently and/or in conjunction with the controller 320 to manage access to the computing device. In one embodiment, the input application 310 can be a firmware embedded onto one or more components of the computing device. In another embodiment, the input application 310 can be an application accessible from a non-volatile computer readable memory of the computing device. The computer readable memory is a tangible apparatus that contains, stores, communicates, or transports the input application 310 for use by or in connection with the computing device. The computer readable memory can be a hard drive, a compact disc, a flash disk, a network drive or any other tangible apparatus coupled to the computing device.

As shown in FIG. 3, the sensor 330 has detected first finger and a second finger at the surface. The sensor 330 also detects a first coordinate corresponding to the first finger position and a second coordinate corresponding to the second finger position. The sensor 330 passes the first coordinate and the second coordinate to the controller 320 and/or the input application 310. If the sensor 330 detects the first finger or the second finger reposition, the sensor 330 can update the first coordinate and the second coordinate provide to the controller 320 and/or the input application 310.

The controller 320 and/or the input application 310 can then determine if the first finger is stationary by detecting for an updated first coordinate from the sensor 330. If no updated first coordinate is received, the first finger will be determined to be stationary and the controller 320 and/or the input application 310 proceed to determine an orientation of the second finger relative to the first finger position. The controller 320 and/or the input application 310 use the first coordinate and the second coordinate when determining the orientation of the second finger relative to the first finger position.

When determining the orientation of the second finger relative to the first finger position, the controller 320 and/or the input application 310 can use the first coordinate and the second coordinate to determine if the second finger is positioned to the left or to the right of the first finger. In another embodiment, the controller 320 and/or the input application 310 can further use the first coordinate and the second coordinate to determine an angle of the second finger relative to the first finger position. The controller 320 and/or the input application 310 can determine if the second finger is angled to the upper right, to the upper left, to the lower right, or the lower left of the first finger position. In other embodiments, when determining the orientation of the second finger relative to the first finger position, the controller 320 and/or the input application 310 can determine if the second finger is repositioning as the first finger remains stationary. Further, the controller 320 and/or the input application 310 can identify a direction of the reposition.

Using information of the orientation of the second finger relative to the first finger position, the controller 320 and/or the input application 310 can proceed to identify a command 360 of the computing device. In one embodiment, before identifying the command 360, the controller 320 and/or the input application 310 determine if the second finger is within proximity of the first finger by comparing the first coordinate to the second coordinate. If the second coordinate is not within the predefined proximity of the first coordinate, the controller 320 and/or the input application 310 will not proceed to identify a command 360 of the computing device associated with the second finger orientation relative to the first finger position.

If the second finger is within proximity of the first finger, the controller 320 and/or the input application 310 proceed to identify a command 360 of the computing device. The command 360 corresponds to an instruction or command for the controller 320 and/or the input application 310 to perform an action. For example, the command 360 can be an instruction to select content, an instruction to launch content, an instruction to launch a menu, an instruction to navigate through content, and/or an instruction to switch between content. The content can include media, a file, and/or an application accessible by the controller 320 and/or the input application 310.

When identifying a command, the controller 320 and/or the input application 310 can access a list, table, and/or database of commands 360. The list, table, and/or database of commands 360 includes one or more commands 360 of the computing device and information of the orientation of the second finger relative to the first finger position corresponding to the commands 360. In one embodiment, the list, table, and/or database of commands 360 can be stored on a storage component of the computing device. In another embodiment, the list, table, and/or database of commands 360 can be included on another device accessible to the controller 320 and/or the input application 310.

For example, if the first coordinate and the second coordinate indicate that the second finger is angled to the upper right of the first finger position, the controller 320 and/or the input application 310 identify the command 360 to be an instruction to launch a menu of presently rendered content of the computing device. If the orientation of the second finger is identified to reposition to the left of the first finger, the controller 320 and/or the input application 310 identify the command 360 to be an instruction to left click. The left click instruction can be a command to select content or select an item or content of the computing device. In another example, if the second finger repositions to the right of the first finger, the controller 320 and/or the input application 310 identify the command 360 to be an instruction to right click.

If the orientation of the second finger is identified to reposition vertically or horizontally, the controller 320 and/or the input application 310 identify the command 360 to be an instruction to scroll vertically or scroll horizontally. The command 360 to scroll vertically or scroll horizontally can be performed on a presented rendered content.

In other embodiments, one or more commands 360 can be used in conjunction with one another. For example, if the second finger is detected to initially reposition to the left of the first finger, the controller 320 and/or the input application 310 initially identify the command to 360 to be a left click command to select content. Once the content has been selected, the user continues to keep the first finger stationary and the second finger repositions vertically or horizontally. If the controller 320 and/or input application 310 detect the second finger repositioning vertically, the command 360 is identified to reposition or move the selected content vertically across a user interface. If the controller 320 and/or input application 310 detect the second finger repositioning horizontally, the command 360 is identified to reposition or move the selected content horizontally across a user interface. In other embodiments, the list, table, and/or database of commands 360 includes additional commands executable by the controller 320 and/or the input application 310 in addition to and/or in lieu of those noted above.

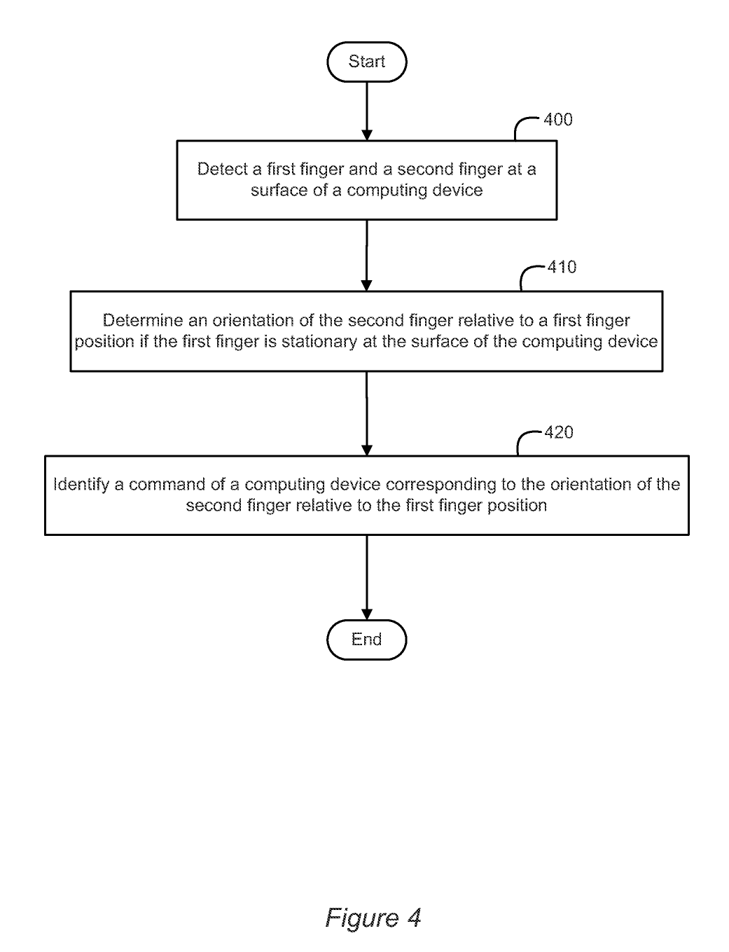

FIG. 4 is a flow chart illustrating a method for detecting an input according to an example. The sensor can initially detect for a first finger and a second finger of at a surface of a computing device at 400. If the first finger and the second finger are detected at the surface, the controller and/or the input application can determine if the first finger is stationary by detecting for the first finger repositioning. If the first finger is detected to be stationary, the controller and/or the input application proceed to determine an orientation of the second finger relative to a first finger position at 410. The controller and/or the input application then identify a command of the computing device corresponding to the orientation of the second finger relative to the first finger position at 420. The method is then complete. In other embodiments, the method of FIG. 4 includes additional steps in addition to and/or in lieu of those depicted in FIG. 4.

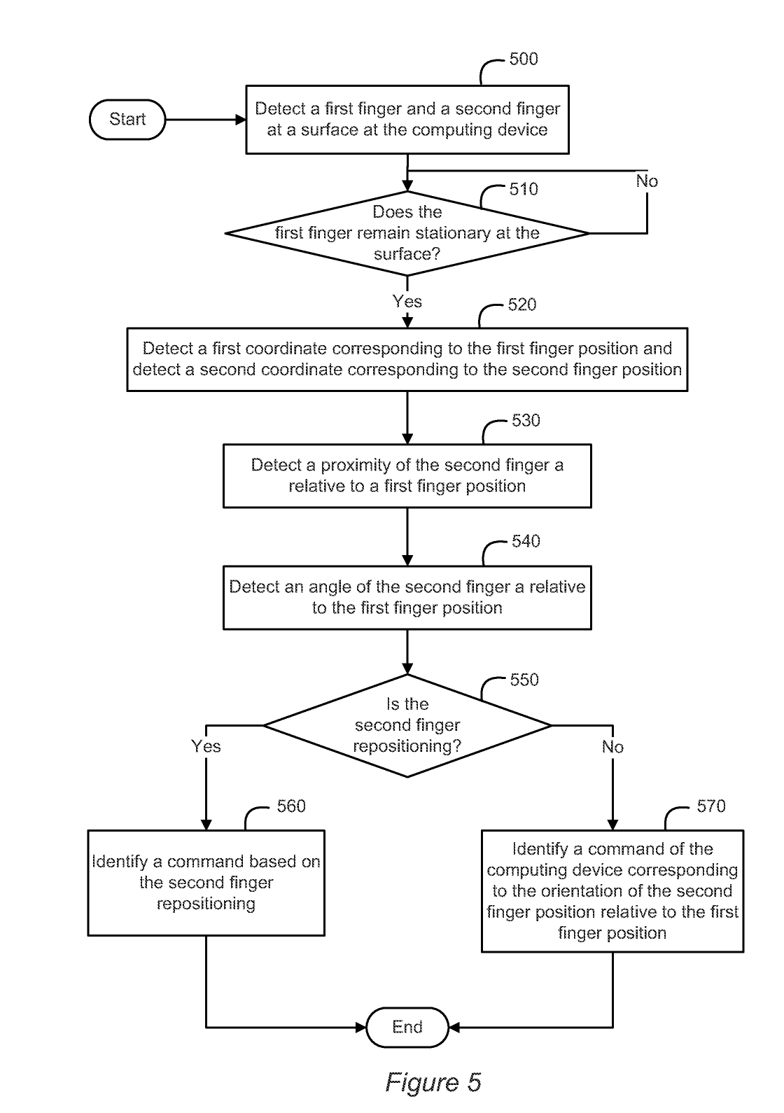

FIG. 5 is a flow chart illustrating a method for detecting an input according to an example. The sensor initially detects for a first finger and a second finger at a surface of the computing device at 500. If the first finger and the second finger are detected at the surface, the controller and/or the input application proceed to determine if the first finger remains stationary at the surface at 510. If the first finger is detected to reposition, the controller and/or the input application continue to detect for the first finger remaining stationary at 510.

If the first finger is detected to be stationary, the controller and/or the input application can proceed to detect an orientation of the second finger relative to the first finger position. As noted above, when determining the orientation of the second finger relative the first finger position, the sensor detects a first coordinate corresponding to the first finger position and a second coordinate corresponding to the second finger position at 520. Using the first coordinate and the second coordinate, the controller and/or the input application can proceed to detect a proximity of the second finger relative to the first finger position at 530. In another embodiment, the controller and/or the input application can use the first coordinate and the second coordinate to determine an angle of the second finger relative to the first finger position at 540.

The controller and/or the input application can also determine if the second finger is repositioning while the first finger remains stationary at 550. If the second finger is repositioning, the controller and/or the input application proceed to identify a command of the computing device based on the second finger repositioning and the first finger remaining stationary at 560. If the second finger is not repositioning, the controller and/or the input application proceed to identify a command of the computing device corresponding to the orientation of the second finger relative to the first finger position at 570. The method is then complete. In other embodiments, the method of FIG. 5 includes additional steps in addition to and/or in lieu of those depicted in FIG. 5.

What is claimed is:

1. A computing device comprising:
a sensor to detect a first finger and a second finger at a surface of the computing device; and
a controller to determine an orientation of the second finger relative to a first finger position if the first finger is stationary at the surface of the computing device;
wherein the controller is to identify a command of the computing device corresponding to orientation of the second finger relative to the first finger position.

2. The computing device of claim 1 wherein the sensor detects for the second finger repositioning if the first finger remains stationary.

3. The computing device of claim 1 wherein the sensor is at least one of a touch surface of the computing device, a touch screen of the computing device, and an image capture component.

4. The computing device of claim 1 wherein the command includes at least one of left click command and a right click command.

5. The computing device of claim wherein the command includes at least one of a vertically scroll command and a horizontally scroll command.

6. The computing device of claim 1 wherein the sensor detects if the first finger position is within proximity of the second finger at the surface.

7. A method for detecting an input comprising:
detecting a first finger and a second finger at a surface of a computing device;
determining an orientation of the second finger relative to a first finger position if the first finger is stationary at the surface of the computing device; and
identifying a command of a computing device corresponding to the orientation of the second finger relative to the first finger position.

8. The method for detecting an input of claim 7 wherein determining an orientation of the second finger includes detecting if a second finger position is located to the right of the first finger position.

9. The method for detecting an input of claim 8 wherein determining an orientation of the second finger includes detecting if the second finger is repositioning as the first finger remains stationary.

10. The method for detecting an input of claim 9 wherein the command is identified as a right click command of the computing device.

11. The method for detecting an input of claim 7 wherein determining an orientation of the second finger includes detecting if a second finger position is located to the left of the first finger position.

12. The method for detecting an input of claim 11 wherein determining an orientation of the second finger includes detecting if the second finger is repositioning as the first finger remains stationary.

13. The method for detecting an input of claim 12 wherein the command is identified as a left click command of the computing device.

14. The method for detecting an input of claim 7 wherein detecting the orientation of the second finger includes detecting an angle of a second finger position relative to the first finger position.

15. The method for detecting an input of claim 14 wherein detecting the angel of the second finger includes detecting a degree of the second finger relative to the first finger position.

16. A non-volatile computer readable medium comprising instructions that if executed cause a controller to:
detect a first finger and a second finger at a surface of a computing device;
determine an orientation of the second finger relative to a first finger position if the first finger remains stationary at the surface; and
identify a command of the computing device corresponding to the orientation of the second finger relative to the first finger position.

17. The non-volatile computer readable medium of claim 16 wherein the first finger and the second finger are included on a single hand of a user.

18. The non-volatile computer readable medium of claim 16 wherein the controller identifies the command based on whether the second finger is positioned to the left or the right of the first finger.

19. The non-volatile computer readable medium of claim 18 wherein the controller identifies the command based on whether the second finger is repositioning to the left of the first finger.

20. The non-volatile computer readable medium of claim 18 wherein the controller identifies the command based on whether the second finger is repositioning to right of the first finger.
